(19) United States
(12) Patent Application Publication
(10) Pub. No.: US 2024/0172763 A1
(43) Pub. Date: May 30, 2024

(54) Manual dough dispenser with grammage regulation

(71) Applicant: Guilherme Torres Lunas, São José dos Campos (BR)

(72) Inventor: Guilherme Torres Lunas, São José dos Campos (BR)

(21) Appl. No.: 17/994,119

(22) Filed: Nov. 25, 2022

(51) Int. Cl. A21C 5/02

(52) U.S. Cl. CPC A21C 5/02

(57) ABSTRACT

The present utility model is an industrial product with a piston compression system driven by a pinion and rack and a wire-cutting system structured by two mechanisms, 4 bars in parallel, coupled in variable synchrony by two manually adjustable speed variator pulleys, and both systems are driven by a crank-driven driving shaft, with application in the dough manufacturing field, aiming at a simple and manual mechanism to provide the precise, quick, and molded portioning of the dough.

The present utility model is an industrial product with a piston compression system activated by a pinion and rack and a wire-cutting system structured by two mechanisms, 4 bars in parallel, coupled in variable synchrony by two speed variator pulleys with manual regulation and both systems are activated by a crank-driven driving shaft, with application in the field of pasta manufacturing aiming at a simple and manual mechanism, providing the precise, quick and molded portioning of the dough.

Currently the technologies in pasta manufacturing are complex with an automatic portioning machine, with independent systems without synchronized coupling between them for operation. It is also noted the high cost of the parts where an electric motor is used specifically for the dough compression system and another is used to move the cutting mechanism, with an electric control panel to control the speed of each system, and according to the models available a robust manufacturing machine is used, with high cost price due to the automatic system, with electric motors, control panel and safety system.

With the intention of solving these problems, the present utility model was developed. It aims to simplify the dough dispensing machine, with lower manufacturing cost and similar cutting time, because it uses synchronized and variable coupling with regulation between the compression and cutting system with a single crank-driven driving shaft, without the need for electric motors, control panel, and safety system.

The utility model may be better understood through the following detailed description, in line with the attached figures, where:

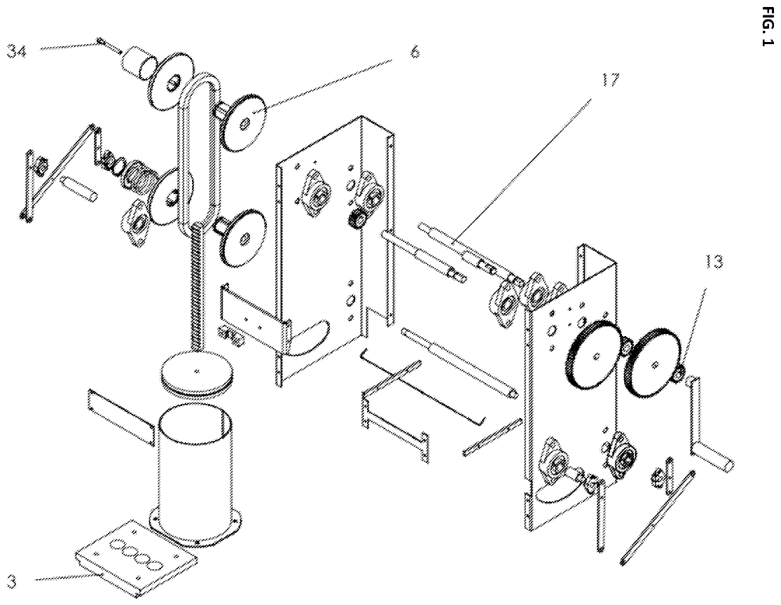

FIG. 1 represents the exploded isometric perspective view.

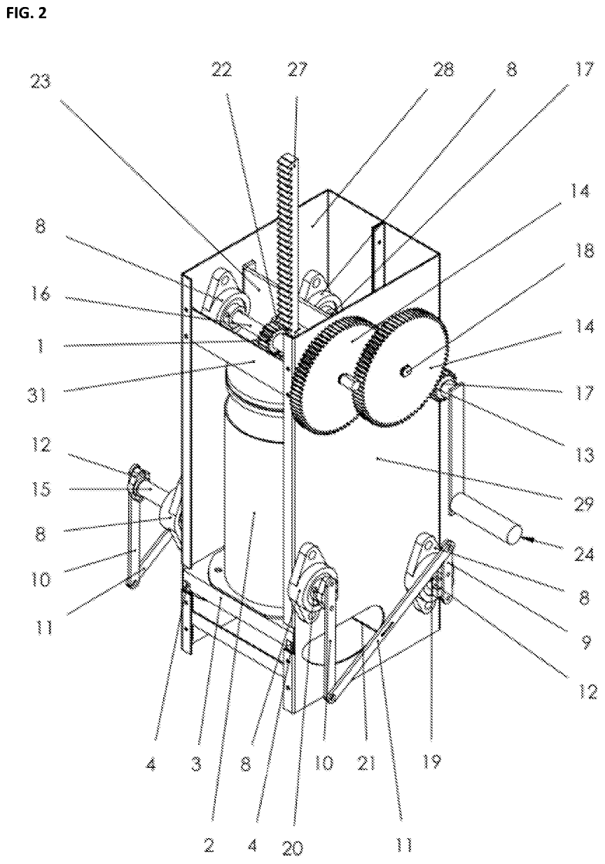

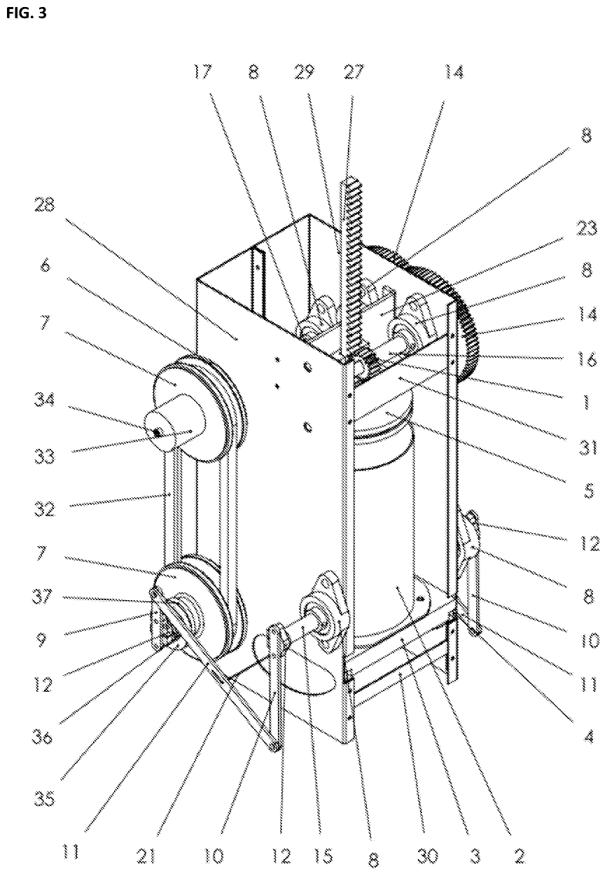

FIGS. 2 and 3 represent the isometric perspective view.

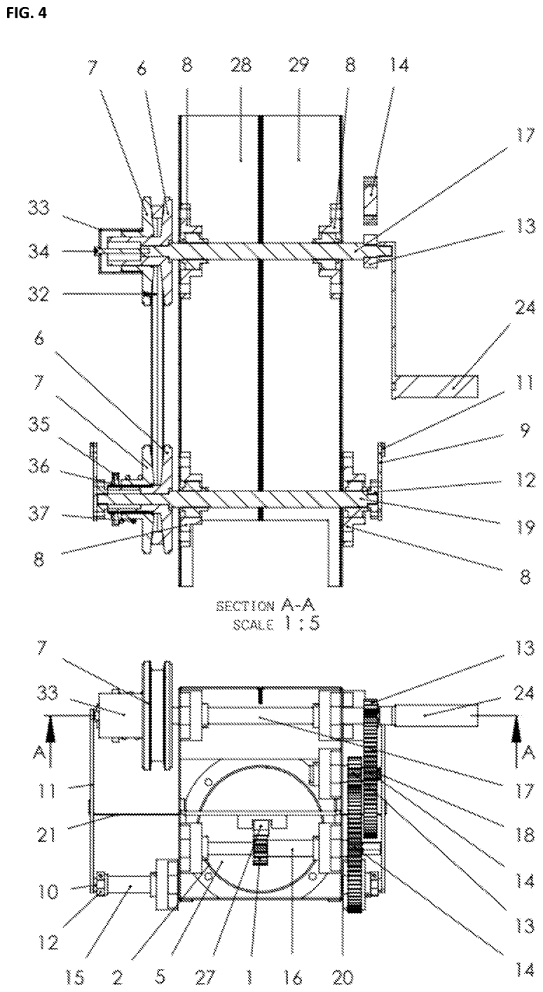

FIG. 4 represents top and front views in section.

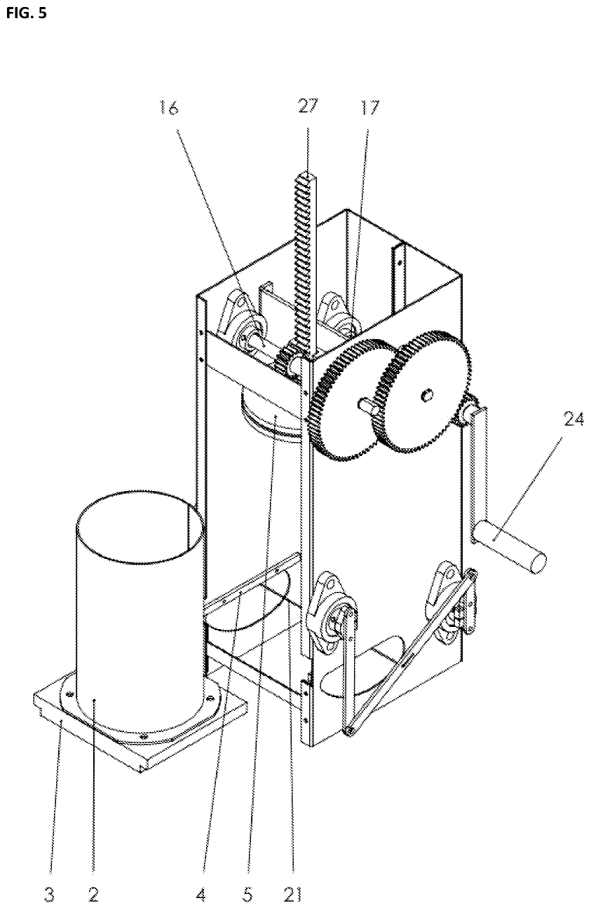

FIG. 5 represents the isometric perspective view.

Referencing these figures, it can be observed that the pinion (1) is a gear that torques the rack, the cylinder (2) is a container that stores the dough and guides the piston, the mold (3) is an extruder matrix that shapes the cross section of the final product, the mold support (4) is the base and guide for the extruder matrix that provides structure, the piston (5) is the disk that pushes the dough, the fixed side pulley (6) is a side of the speed variator pulley that supports the movable pulley, the moving side pulley (7) is a side of the speed variator pulley that varies the diameter of the pulley, bearing/rolling (8) is the set for supporting and rolling the shafts, crank link (9) is a bar fixed to the shaft that transmits motion to the coupler, follower link (10) is a bar fixed to the driven shaft that guides the movement of the coupler, coupler link (11) is a bar clamped to the crank and to the follower that provides the motion of the cutting edge, router bearing (12) is a clamp to the shaft that performs the fixed coupling with the crank and follower link, reduction pinion (13) is a gear that performs torque to the reducer, driven gear (14) is a gear that performs motion to the reducer, left mechanism shaft (15) is a shaft that guides the follower link, rack pinion shaft (16) is a shaft that transmits power to the compression system, main shaft (17) is a driving shaft that transmits power to both systems, intermediate shaft (18) is a shaft that transmits motion in the reducer, mechanism shaft (19) is a shaft that transmits power to the cutting system, right mechanism shaft (20) is a shaft that guides the follower link, cutting wire (21) is a wire that sections the extruded dough, rack guide (22) is a support for moving the rack, rack internal lock (23) is a frame for the rack guide part, crank (24) is a crank that provides power to the machine, rack (27) is a linear gear that transmits motion to the compression system, left frame (28) is one side of the main machine frame, right frame (29) is one side of the main machine frame, lower lock (30) is a structure for locking the main structure, upper lock (31) is a structure for locking the main structure, belt (32) is a transmission belt that connects the variable speed pulleys, cup (33) is a structure to guide the adjustment screw of the variable speed pulley, screw (34) is a screw that adjusts the diameter of the speed variator pulley, lock washer (35) is a lock washer with a tab for fitting the speed variator pulley spring, snap ring (36) is a snap ring that positions and secures the lock washer with a tab, spring (37) is a spring that presses to increase the diameter of the speed variator pulley.

The crank (24) that provides the driving force to the main shaft (17) that provides force to the two systems, the extrusion system, composed of the reduction with two reduction pinion gears (13) and two driven gears (14), the intermediate shaft (18) and the rack pinion shaft (16), transmitting the force to the pinion (1) and rack (27), which vertically moves the piston (5) concentric with the cylinder (2) pressing the dough against the mold (3) and the cutting system that also receives the driving force from the main shaft (17) that provides power to the speed variator transmission with two pairs of fixed side pulleys (6) and moving side pulleys (7), one coupled to the main shaft (17) manually adjusted by tightening the screw (34) and cup (33), transmitting this force through the belt (32) to the other pulley coupled to the mechanism shaft (19), which in its ends moves the crank links (9) parallel to each other, coupled to the coupler links (11), which are coupled to the follower link (10), which due to its geometry allows the cutting wire (21) fixed in the middle of the two coupler links (11) to move to tangent the mold (3) and section the extruded mass. In the present arrangement, the speed variator transmission contemplates the grammage regulation by varying the speed of the cutting wire (21), with a simple tightening of the screw (34) being tightened to the the main shaft (17) the mobile side pulley (7) approaches the fixed side pulley (6) increasing the diameter and making the belt (32) move away from the center, increasing the speed of the cutting mechanism because the pulley on the moving side (7) of the mechanism shaft (19) moves away from the fixed side (6) mechanically with the help of the spring (37) that compresses between the moving side (7) and the lock washer (35) locked by the snap ring (36), consequently decreasing the height of the final product and its weight. To increase the product's weight and height it is necessary to loosen the screw (34) automatically moving away the movable side pulley (7) from the fixed side pulley (6) of the main shaft (17), due to the spring pressure made to approximate the movable side pulley (7) from the fixed side pulley (6) of the mechanism shaft (19). The machine frame is comprised of the left frame (28) fixed on the right frame (29) and locked on the front parts by the lower lock (30) and upper lock (31) and rack internal lock (23), the six shafts are fixed by nine bearing/rollings (8), where the main shaft (17) is double supported on the inner parts by two bearing/rollings (8), the intermediate shaft (18) is balanced by only one bearing/rolling (8) on the inner part, the rack pinion shaft (16) is double supported on the inside by two bearing/rollings (8), the mechanism shaft (19) is double supported, one on the inside of the left frame (28) and one on the outside of the right frame (29) by two bearing/rollings (8), the left mechanism shaft (15) is balanced by only one bearing/rolling (8) on the outside and the right mechanism shaft (20) is balanced with only one rolling/bearing (8) on the outside. The crank link shafts (9) are attached to the ends of the mechanism shaft (19) each by router bearing (12), and the follower link shafts (10) are also attached by the left mechanism shaft (15) and right mechanism shaft (20) cach by router bearing (12). In the extrusion system a rack guide (22) is used, and to support the mold (3), two mold supports (4) are used, one fixed to the left frame (28) and the other to the right frame (29). Thus, the dispenser works as usual, i.c., a dough compression system extrudes the dough against the mold holes (3) and a cutting system tangents the mold (3) sectioning the dough, producing products with desired shapes and heights. When the cup is empty, the rack (27) and piston (5) return vertically with the counter force transmitted by the crank (24) until the cylinder (2) and mold (3) are free to remove it and a new portion of dough is introduced into the uncovered opening. Once the movement is made in the opposite direction the dispenser is put back in the position of use.

It works in a manual and simple way to portion and shape dough, for example: cheese bread, gnocchi, cookie, butter cookie, chipa, sour cassava starch cookie, among others.

1. A manual dough dispenser with grammage regulation characterized by synchronized and variable coupling between the compression system and the dough cutting mechanism with only one driving shaft.

2. A manual dough dispenser with grammage regulation, according to claim 1, characterized by having manual adjustment of the cutting speed, consequently performing the portioning.

3. A manual dough dispenser with grammage regulation, according to claim 2, characterized by having the driving movement of the systems in a manual way by crank.

4. A manual dough dispenser with grammage regulation, according to claim 3, characterized by having a simple mechanism with the effect of portioning and molding dough accurately and quickly.
